(19) United States
(12) Patent Application Publication
(10) Pub. No.: US 2004/0242334 A1
(43) Pub. Date: Dec. 2, 2004

(54) Electric power steering device

(75) Inventors: Jun Hamakita, Osaka (JP); Yoshikazu Kawada, Nara (JP)

Correspondence Address: MCGINN & GIBB, PLLC, 8321 OLD COURTHOUSE ROAD, SUITE 200, VIENNA, VA, 22182-3817, US

(73) Assignee: Koyo Seiko Co., Ltd., Osaka (JP)

(21) Appl. No.: 10/796,301

(22) Filed: Mar. 10, 2004

(30) Foreign Application Priority Data
Mar. 14, 2003 (JP) P. 2003-070522

(51) Int. Cl. F16N 1/00

(52) U.S. Cl. 464/7

(57) ABSTRACT

An electric power steering device for transmitting a rotation of a motor for assisting operation of steering which is reduced via a reduction gear to a steering mechanism includes: a male type joint member and a female type joint member which are jointed each other for transmitting the rotation of the motor to the reduction gear; and lubricant including base oil having kinetic viscosity of 1000 to 5000 mm²/s (40° C.), worked penetration of which is not more than 300, and which is charged between the male type joint member and the female type joint member.

### BACKGROUND OF THE INVENTION

The present invention relates to an electric power steering device provided with a reduction gear.

A reduction gear is applied to an electric power steering device for vehicle use. For example, in the case of a column type EPS, torque generated by an electric motor is transmitted to a worm shaft and further to a worm wheel, so that the motor speed can be reduced and an output power of transmitted torque can be intensified. After that, the torque is given to a column so as to assist steering operation conducted by a driver (Refer to JP-A-2002-211416).

In the above electric power steering device, the rotary shaft of the motor and the worm shaft are usually connected and driven by a joint, which is composed of a male type joint member and a female type joint member, such as a spline joint. In the case of a product of the normal specification, it is common to charge grease of low viscosity into the engagement portion of both joint members of the joint, for example, kinetic viscosity of base oil of the grease is 100 to 300 mm²/s (40° C.), and worked penetration of the grease stipulated by Japanese Industrial Standard JIS K2220 1993 is 200 to 280.

However, depending upon the condition of use, gear noise is generated in the above engagement portion and transmitted into a vehicle room, which hurts the driver's feelings.

In order to solve the above problem of gear noise, they take a countermeasure of inserting an O-ring into the engagement portion.

In the case of an electric power steering device of the high temperature specification, which is suitably used in a region of high temperatures, for example, the average atmospheric temperature is not lower than 40° C. in the region, in order to reduce gear noise, an O-ring is inserted into the engagement portion, and instead of common grease of low viscosity, grease of high viscosity, for example, kinetic viscosity of base oil of the grease is 10000 to 30000 mm²/s (40° C.) and worked penetration of the grease is 200 to 260, is charged into the engagement portion.

However, when the O-ring is inserted into the engagement portion as described above, the following problems may be encountered. The number of parts is increased, and further the number of man-days for assembling work is increased. Accordingly, productivity of the electric power steering device is deteriorated, and the manufacturing cost is raised.

Especially, in the case of an electric power steering device into which grease of high viscosity is charged, when the electric power steering device is assembled in the domestic area, viscosity of the grease is too high. Therefore, it is very difficult to insert and engage the male type engagement member with the female type engagement member under the condition that a predetermined quantity of grease is supplied onto an outer face of the male type joint member and/or an inner face of the female type joint member. Accordingly, the working property is remarkably deteriorated.

### SUMMARY OF THE INVENTION

An object of the present invention is to provide a new electric power steering device characterized in that: in the case of an electric power steering device of the normal specification, the O-ring is omitted, so that the productivity can be enhanced and the manufacturing cost can be reduced; and in the case of an electric power steering device of the high temperature specification, the working property of assembling work is excellent.

In order to solve the above problems, the present invention provides an electric power steering device in which the rotary speed of an electric motor for assisting operation of steering is reduced via a reduction gear and transmitted to a steering mechanism, characterized in that: a rotary shaft of the motor and an input shaft of the reduction gear are connected with each other and driven by a joint composed of a male type joint member and a female type joint member; and lubricant,

(1) the kinetic viscosity of base oil of which is 1000 to 5000 mm²/s (40° C.),

(2) the worked penetration of which is not more than 300, is charged into an engagement portion of both joint members of the joint.

According to the present invention, instead of the grease of low or high viscosity, which is conventionally used, the aforementioned lubricant of intermediate viscosity, for example, the grease of intermediate viscosity is charged into the engagement portions of both joint portions. Therefore, in the case of the normal specification, even when the O-ring is omitted, the generation of gear noise can be positively prevented. When the O-ring is omitted, the number of parts and the number of man-days of assembling can be decreased. Accordingly, the productivity of the electric power steering device can be enhanced, and the manufacturing cost of the electric power steering device can be reduced.

In the case of the high temperature specification, when the above lubricant of intermediate viscosity and the O-ring are combined with each other, while the generation of gear noise is being prevented in the environment of high temperatures to the same degree as that of the conventional grease of high viscosity, the working property in the case of assembling in the domestic area can be improved.

### BRIEF DESCRIPTION OF THE DRAWINGS

FIG. 1 is a sectional view showing an outline of the electric power steering device of an embodiment of the present invention.

FIG. 2 is a sectional view taken on line II-II in FIG. 1.

FIG. 3 is an enlarged exploded perspective view showing a spline joint connecting the rotary shaft of a motor with the worm shaft.

### DETAILED DESCRIPTION OF PREFERRED EMBODIMENTS

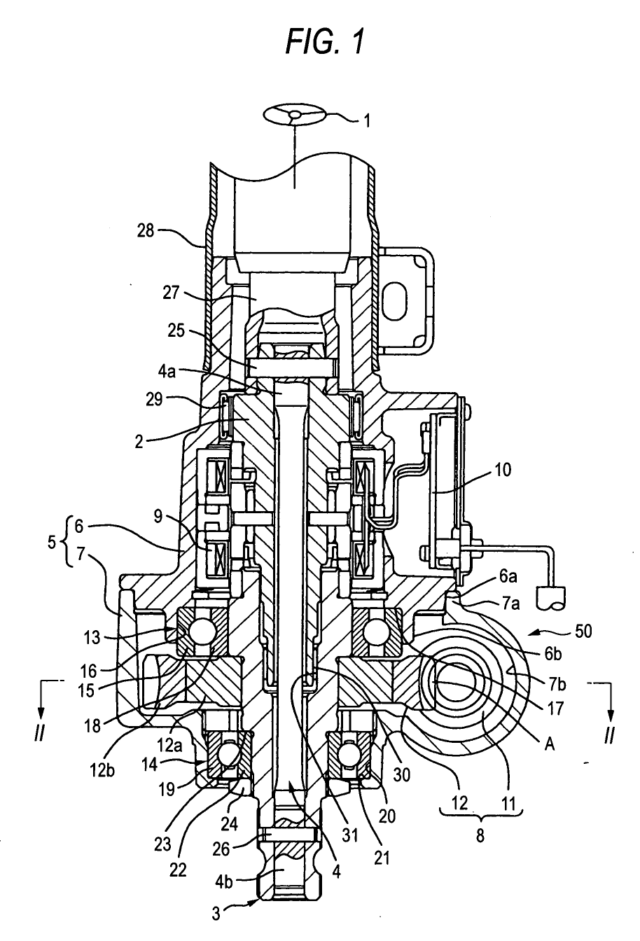

FIG. 1 is a sectional view showing an outline of the electric power steering-device of an embodiment of the present invention.

Referring to FIG. 1, in the electric power steering device of this embodiment, the first steering shaft 2, which is an input shaft to which the steering wheel 1 is attached, and the second steering shaft 3, which is an output shaft connected to a steering mechanism (not shown) such as a rack and pinion, are coaxially connected with each other via the torsion bar 4.

The housing 5 for supporting the first steering shaft 2 and the second steering shaft 3 is made of, for example, aluminum alloy and attached to a vehicle body (not shown). The housing 5 is constituted by a sensor housing 6 and gear housing 7 which are engaged with each other. Specifically, the gear housing 7 is formed into a cylindrical shape, and the annular edge portion 7a of the upper end of the gear housing 7 is engaged with the annular step portion 6a on the outer circumference of the lower end of the sensor housing 6. The gear housing 7 accommodates a worm shaft gear mechanism 8 which is a speed reduction mechanism, and the sensor housing 6 accommodates a torque sensor 9, control board 10 and so forth. The reduction mechanism 50 is formed by accommodating the worm shaft gear mechanism 8 in the gear housing 7.

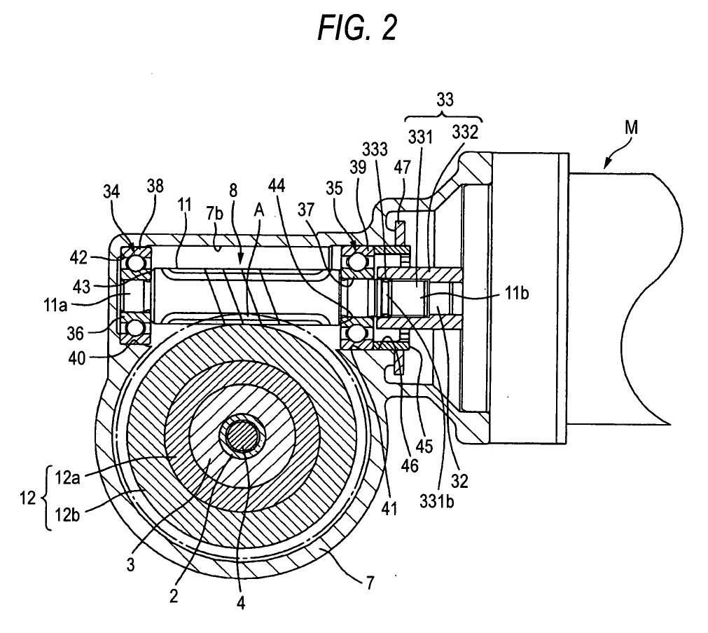

As shown in FIG. 2, the worm shaft gear mechanism 8 includes: a worm shaft 11 connected with the rotary shaft 32 of electric motor M via the spline joint 33; and a worm wheel 12 which is meshed with the worm shaft 11 and arranged in the intermediate portion in the axial direction of the second steering wheel 3 and regulated so that the worm wheel 12 can not be moved in the axial direction as shown in FIG. 1. The worm shaft 11 is pivotally supported by the gear housing 7 via a pair of bearings 34, 35.

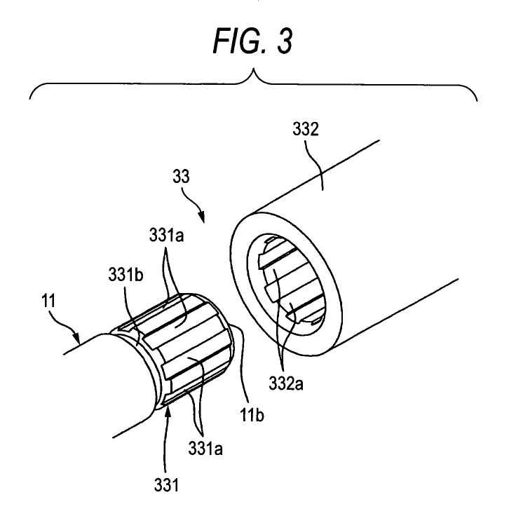

As shown in FIG. 3, the spline joint 33 includes: a spline shaft 331 which is a male type joint member formed in such a manner that a plurality of key grooves 331a are machined on the outer circumferential face of the worm shaft 11 on the other end portion 11b side; and a cylindrical body connected with the rotary shaft 32 of electric motor M so that the cylindrical body can be rotated integrally with the rotary shaft 32. The cylindrical body is provided with a boss 332, on the inner circumferential face of which protrusions 332a engaging with the key grooves of the above spline shaft 331 are formed. In a gap formed between the spline shaft 331 and the boss 332, grease of intermediate viscosity described later is charged.

In this connection, FIG. 3 is a view showing a case of the normal specification, and no O-ring is inserted between the spline shaft 331 and the boss 332. However, in the case of the high temperature specification, the O-ring 333 may be inserted into the groove 331b provided in the spline shaft 331 as shown in FIG. 2.

The worm wheel 12 includes: an annular mandrel 12a connected with the second steering shaft 3 so that the mandrel 12a can be rotated integrally with the second steering shaft 3; and a synthetic resin member 12b, which surrounds the circumference of the mandrel 12a, on the outer circumference of which teeth are formed. For example, the mandrel 12a is inserted into the metallic die when the synthetic resin member 12b is formed by means of resin molding.

Conventionally, the synthetic resin member 12b is made of polyamide resin such as MC (monomer casting) nylon. However, the water absorption degree of the gear made of polyamide resin is so high that the gear absorbs water and expands greatly. As a result, an intensity of torque of the electric power steering device is made to fluctuate greatly.

Therefore, conventionally, the first rolling bearing 13 and the second rolling bearing 14 shown in FIG. 1 are provided with a seal described in the above Patent Document 1 so as to enhance the airtightness of the gear housing 7 in which the worm wheel 12 is accommodated. Alternatively, although not shown in the drawing, in the case where a gap is formed in the connecting portion of the sensor housing 6, the gap must be filled with grommet, which increases the number of parts and the number of man-days in the process of assembling.

In order to solve the above problems, when the synthetic resin member 12b is made of resin such as polyacetal or polybutylene terephthalate, the dimensional change caused by water absorption of which is smaller than that of polyamide resin, or when the synthetic resin member 12b is made of resin of polyamide such as PA12 or MDX6, the dimensional change caused by water absorption of which is smaller than that of other resin of polyamide, the seal can be omitted from the first rolling bearing 13 and the second rolling bearing 14, that is, the structure can be simplified, and further grommet can be omitted. Therefore, the number of parts can be decreased and the number of man-days of assembling can be reduced.

In the gear housing 7, lubricant is charged into the region at least including the meshing portion A in which the worm shaft 11 and the worm wheel 12 are meshed with each other. Lubricant may be charged only into the meshing portion A. Alternatively, lubricant may be charged into the entire peripheral regions of the meshing portion A and the worm shaft 11. Alternatively, lubricant may be charged into the entire gear housing 7.

The second steering shaft 3 is pivotally supported by the first rolling bearing 13 and the second rolling bearing 14 which are arranged in the axial direction interposing the worm wheel 12.

The outer ring 15 of the first rolling-bearing 13 is held being engaged in the bearing holding hole 16 provided in the cylindrical protrusion 6b at the lower end of the sensor housing 6. An upper end face of the outer ring 15 of the first rolling bearing 13 comes into contact with the annular step portion 17. Therefore, the first rolling bearing 13 is prevented from being moved upward in the axial direction with respect to the sensor housing 6. On the other hand, the inner ring 18 of the first rolling bearing 13 is engaged with the second steering shaft 3 by tight-fit. A lower end face of the inner ring 18 comes into contact with an upper end face of the mandrel 12a of the worm wheel 12.

The outer ring 19 of the second rolling bearing 14 is held being engaged in the bearing holding hole 20 of the gear housing 7. A lower end face of the outer ring 19 of the second rolling bearing 14 comes into contact with the annular step portion 21, so that the gear housing 7 can be prevented from being moved downward in the axial direction. The inner ring 22 of the second rolling bearing 14 is attached to the second steering shaft 3 in such a manner that the inner ring 22 can be rotated integrally with the second steering shaft 3 and can not be relatively moved in the axial direction. The inner ring 22 is interposed between the step portion 23 of the second steering shaft 3 and the nut 24 screwed into the screw portion of the second steering shaft 3.

The torsion bar 4 penetrates the first steering shaft 2 and the second steering shaft 3. The upper end 4a of the torsion bar 4 is connected with the first steering shaft 2 by the connecting pin 25 so that the torsion bar 4 and the first steering shaft 2 can be integrally rotated. The lower end 4b of the torsion bar 4 is connected with the second steering shaft 3 by the connecting pin 26 so that the torsion bar 4 and the second steering shaft 3 can be integrally rotated. The lower end of the second steering shaft 3 is connected with a steering mechanism such as a rack and pinion mechanism via an intermediate shaft not shown.

The above connecting pin 25 connects the third steering shaft 27, which is arranged coaxially with the first steering shaft 2, with first steering shaft 2 so that the third steering shaft 27 and the first steering shaft 2 can be rotated integrally with each other. The third steering shaft 27 penetrates the tube 28 composing the steering column.

An upper portion of the first steering shaft 2 is pivotally supported by the sensor housing 6 via the third rolling bearing 29 composed of a needle-shaped roller bearing. The contracted diameter portion 30 of the lower portion of the first steering shaft 2 and the hole 31 in the upper portion of the second steering shaft 3 are engaged with each other being provided with a predetermined play in the rotational direction so that a relative rotation between the first steering shaft 2 and the second steering shaft 3 can be regulated in a predetermined range.

Next, referring to FIG. 2, the worm shaft 11 is pivotally supported by the fourth rolling bearing 34 and the fifth rolling bearing 35 which are held by the gear housing 7. The fourth rolling bearing 34 and the fifth rolling bearing 35 are respectively composed of, for example, a ball bearing.

The inner rings 36, 37 of the fourth rolling bearing 34 and the fifth rolling bearing 35 are engaged with a corresponding contracted portion of the worm shaft 11. The outer rings 38, 39 of the fourth rolling bearing 34 and the fifth rolling bearing 35 are respectively held by the bearing holding holes 40, 41 of the gear housing 7.

The gear housing 7 includes a portion 7b opposing to one portion of the circumferential face of the worm shaft 11 in the radial direction. The outer ring 38 of the fourth rolling bearing 34 for supporting one end portion 11a of the worm shaft 11 is positioned coming into contact with the step portion 42 of the gear housing 7. On the other hand, when the inner ring 36 of the fourth rolling bearing 34 comes into contact with the positioning step portion 43 of the worm shaft 11, a movement of the worm shaft 11 to the other end portion 11b, in which the spline shaft 331 is formed, is regulated.

When the inner ring 37 of the fifth rolling bearing 35 for supporting the neighborhood of-the other end portion 11b (end portion on the joint side) of the worm shaft 11 comes into contact with the positioning step portion 44 of the worm shaft 11, a movement of the worm shaft 11 to one end portion 11a side is regulated.

The outer ring 39 of the fifth rolling bearing 35 is pushed to the fourth rolling bearing 34 side by the screw member 45 used for adjusting a pre-load. When the screw member 45 is screwed into the screw hole 46 formed in the gear housing 7, a pre-load is given to the pair of rolling bearings 34, 35, and the worm shaft 11 is positioned in the axial direction. Reference numeral 47 is a lock nut engaged with the screw member 45 so that the screw member 45 can be fixed after the pre-load has been adjusted.

(Lubricant)

As described before, in the electric power steering device of the above embodiment, lubricant of intermediate viscosity, especially grease,

(1) the kinetic viscosity of base oil of which is 1000 to 5000 mm²/s (40° C.), and

(2) the worked penetration of which is not more than 300, is charged into a gap formed between the spline shaft 331 and the boss 332 of the spline joint 33.

The reason why the kinetic viscosity of base oil of lubricant is limited into the above range is described as follows. When the kinetic viscosity of base oil of lubricant is lower than this range, the viscosity becomes too low. Therefore, it is impossible to prevent the generation of gear noise in the spline joint 33. When the kinetic viscosity of base oil of lubricant is higher than this range, the viscosity becomes too high. Therefore, the working property of assembling is deteriorated. In this connection, in order to more positively prevent the generation of gear noise, it is preferable that the kinetic viscosity of base oil is not less than 1500 mm²/s (40° C.) in the above range. In order to further enhance the working property of assembling, it is preferable that the kinetic viscosity of base oil is not more than 2500 mm²/s (40° C.) in the above range.

The reason why the worked penetration of lubricant is limited to a value not more than 300 is described as follows. In the case where the worked penetration of lubricant exceeds this range, even when the kinetic energy of base oil is in the above range, the viscosity is raised too high, and the working property of assembling is deteriorated.

In this connection, in order to further enhance the working property of assembling, it is preferable that the worked penetration is not more than 260 in the above range. In order to more positively prevent the generation of gear noise, it is preferable that the worked penetration is not less than 200 in the above range.

It should be noted that the present invention is not limited to the above specific embodiment but variations may be made by one skilled in the art without departing the scope of the patent of the present invention.

For example, the spline joint is exemplarily shown in the embodiment, however, the other type joint may be used. The reduction gear composed of a worm shaft and worm wheel is exemplarily shown in the embodiment, however, for example, a reduction gear composed of a bevel gear, hypoid gear or helical gear may be used.

What is claimed is:

1. An electric power steering device for transmitting a rotation of a motor for assisting operation of steering which is reduced via a reduction gear to a steering mechanism, the electric power steering device comprising:
a male type joint member and a female type joint member which are jointed each other for transmitting the rotation of the motor to the reduction gear; and
lubricant including base oil having kinetic viscosity of 1000 to 5000 mm²/s (40° C.), worked penetration of which is not more than 300, and which is charged between the male type joint member and the female type joint member.

2. The electric power steering device according to claim 1, wherein the kinetic viscosity of the base oil is not less than 1500 mm²/s.

3. The electric power steering device according to claim 1, wherein the kinetic viscosity of the base oil is not more than 2500 mm²/s.

4. The electric power steering device according to claim 1, wherein the worked penetration of the lubricant is not more than 260.

5. The electric power steering device according to claim 1, wherein the worked penetration of the lubricant is not less than 200.
